(19) United States
(12) Patent Application Publication
(10) Pub. No.: US 2009/0297849 A1
(43) Pub. Date: Dec. 3, 2009

(54) SILICON-BASED NANOWIRES AND METHOD OF DISPERSING THESE NANOWIRES

(75) Inventors: Alexandre CARELLA, Mazeres Lezons (FR); Jean-Pierre SIMONATO, Sassenage (FR); Clement SUSPENE, Tulle (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COMMISSARIAT A L'ENERGIE ATOMIQUE, Paris (FR)

(21) Appl. No.: 12/473,676

(22) Filed: May 28, 2009

(30) Foreign Application Priority Data
May 30, 2008 (FR) 08 02975

(51) Int. Cl. B32B 1/00; B05D 5/12

(52) U.S. Cl. 428/388; 427/117; 977/762

(57) ABSTRACT

The invention provides a nanowire made of a silicon-based material, the surface of which includes at least one gold protuberance, said nanowire being noteworthy in that an organosulfur derivative is grafted onto at least one of these gold protuberances.

### BACKGROUND OF THE INVENTION

The invention relates to nanowires made of a silicon-based material and to a method of dispersing these nanowires in a solvent.

### DESCRIPTION OF THE PRIOR ART

Nanowires made of a silicon-based material are quasi-one-dimensional objects of nanoscale size. They have a high shape ratio, i.e. a length/diameter ratio, greater than 10, with at least two dimensions being less than 1 micrometer.

The expression “nanowires made of a silicon-based material” denotes, in the above and following text and in the appended claims, silicon nanowires, nanowires made of a silicon/germanium alloy SiGe, or nanowires made of an Si/SiGe composite. Most commonly, these silicon or silicon-based materials are doped.

Depending on their doping, these nanowires have a semiconductor character or a conductive character, thus making them species of interest for many studies and applications, especially in the field of large-area electronics, sensors, thermoelectricity, optronics, etc.

However, at the present time their use is restricted as it is difficult to handle them in liquid phase.

This is because to form a stable dispersion of these nanowires in a liquid medium is very difficult, especially with a uniform distribution of nanowires throughout the liquid volume, i.e. nanowires well distributed within the liquid volume.

However, it is essential to be able to obtain homogeneous solutions of these nanowires in various liquid media, for example for dispersing them in a controlled fashion and for being able to chemically modify their surface using conventional organic chemistry processing means.

One method of dispersing gold nanowires in a polar solvent, such as isopropanol, is described in J. Appl. Phys., 2007, 102, 034302.

However, this method requires very precise ultrasonic conditions that are difficult to achieve in an industrial process. Moreover, even though the dispersion obtained is homogeneous, it is not stable for a long time.

At the present time, no method for obtaining a stable dispersion of nanowires made of a silicon-based material in a solution, in particular in apolar solvents, is known.

But, nanowires made of a silicon-based material are often used to synthesize composites with a polymer in order to fabricate semiconductor matrices.

In this type of synthesis, the processing of nanowires made of a silicon-based material is difficult at the present time because it is impossible to disperse the silicon-based nanowires in a solvent compatible with organic molecules.

Nanowires made of a silicon-based material may be synthesized by various processes.

One particular process consists in synthesizing the silicon-based nanowire by chemical vapor deposition (CVD) of a precursor in the presence of a catalyst.

Various precursors containing silicon or germanium atoms are used (for example SiH₄, Si₂H₆, SiH₂Cl₂, SiCl₄, GeH₄, GeCl₄, etc.) and one much used catalyst is gold, as described in Nanoletters 2008, 8, 362-368.

In that document it is mentioned that, at the end of growth, the gold is found at the tip of the synthesized nanowire but may, depending on the operating conditions, be partly on the surface along the sides of the nanowire.

It is possible to synthesize nanowires containing many gold particles (up to 10⁵ particles/μm²) on the walls.

Moreover, thiol organic compounds are molecules well known for dissolving and dispersing gold nanoparticles.

One method used to disperse gold nanoparticles with a size of less than 100 nanometers is described in Nano letters 2007, 7, 2881-2885).

However, in that document the gold particles are either gold nanospheres or gold nanorods, i.e. nano-objects having a lower shape ratio, i.e. a length/diameter ratio of 1 to 10, than that of the silicon-based nanowires according to the invention but most particularly not having one dimension of the order of a micrometer.

The objective of the invention is to palliate the drawbacks of the methods in the prior art of dispersing nanowires made of a silicon-based material in any solvent.

### SUMMARY OF THE INVENTION

For this purpose, the invention provides a method of dispersing nanowires made of a silicon-based material, which include at least one gold protuberance on their surface, in a solvent, which method includes a step of grafting, onto at least one gold protuberance of each nanowire, an organosulfur derivative of formula I below:

X—S—R

in which:
X is hydrogen or a thiol-protecting group; and
R is a C₂ to C₄₀ hydrocarbon group possibly containing at least one heteroatom.

R may comprise a radical chosen from a hydroxyl radical, an amine radical, an aromatic radical, a perfluorinated radical, an ester radical, an amide radical and/or a sulfonic ester radical.

When the solvent is a polar solvent, the group R in formula I is preferably chosen from a polyethylene glycol group, or an organic group possibly containing a heteroatom and comprising at least two carbon atoms and at least one radical chosen from a hydroxyl radical, an amine radical, an amide radical and a sulfonic ester radical.

However, when the solvent is an apolar solvent, R in formula I is preferably an organic group possibly containing at least one heteroatom and comprising at least two carbon atoms and at least one aromatic radical, or is a C₂ to C₄₀ alkyl group possibly containing at least one heteroatom. One organosulfur derivative in this case is octadecanethiol.

In contrast, when the solvent is a perfluorinated solvent, R in formula I is preferably an organic group possibly containing at least one heteroatom different from fluorine but containing at least two carbon atoms and at least one perfluorinated radical.

In the latter case, the organosulfur derivative of formula I is preferably 1H,1H,2H,2H-perfluorodecanethiol.

In a first preferred, way of implementing the method of the invention, the nanowires to be dispersed are made of silicon.

In a second preferred way of implementing the method of the invention, the nanowires are made of an SiGe alloy.

Finally, in a third preferred way of implementing the method of the invention, the nanowires are made of an Si/SiGe composite.

The invention also provides a nanowire made of a silicon-based material, the surface of which includes at least one gold protuberance, an organosulfur derivative being grafted onto at least one of these gold protuberances, wherein the organosulfur derivative is chosen from 1H,1H,2H,2H-perfluorodecanethiol and octadecanethiol.

Preferably, the silicon-based material is an SiGe alloy or an Si/SiGe composite.

### DESCRIPTION OF THE PREFERRED EMBODIMENTS

The invention will be better understood and other advantages and features thereof will become more clearly apparent on reading the following explanatory description.

Nanowires made of a silicon-based material, as defined in the invention, have a very high shape ratio, greater than 10.

They may be made of silicon, or made of a silicon/germanium alloy or made of an Si/SiGe composite, whether these be doped or undoped.

Their shape ratio greater than 10 and their large size, up to several micrometers in length, this length being preferably comprised between 1 and 10 micrometers inclusive, make them intrinsically difficult to disperse. In addition, owing to the nature of the material from which they are made, they interact little with solvents, and their elongate shape and their rigidity are drawbacks in their dispersion since their morphology cannot be adapted so as to increase their interaction with solvents, as polymers or carbon nanotubes do. However, gold nanorods have a somewhat lower aspect ratio than nanowires and a very small size, thereby making it easier to disperse them.

Surprisingly, it has been discovered that by grafting organosulfur derivatives onto the walls of long silicon-based nanowires it is possible to disperse them in all liquid phases, depending on the organosulfur derivative chosen.

Preferably, the nanowires made of a silicon-based material of the invention are nanowires fabricated by the CVD method using gold as catalyst.

Specifically, owing to the way they are synthesized, these nanowires have gold protuberances on their surface, something which was considered in the prior art to be a drawback as it was then necessary to remove this gold.

However, against all expectation, the small number of gold particles (10⁵ particles/μm²) present on the surface of the silicon-based nanowires is sufficient to enable them to be dispersed when an organosulfur derivative is grafted onto at least one of these gold protuberances.

Of course, it will be clearly apparent to a person skilled in the art that any nanowire, whatever the method of synthesizing it, having gold protuberances on its surface, these gold protuberances being either obtained directly during the synthesis or by a post-treatment, may be dispersed in a solvent when an organosulfur derivative is grafted onto at least one of the gold protuberances present on the surface of each nanowire.

The organosulfur derivative must be chosen so as to contain a group having a strong affinity for the solvent in which the silicon-based nanowires are to be dispersed.

Thus, the organosulfur derivative grafted onto the at least one gold particle has the general formula I below:

X—S—R

in which:
X is hydrogen or a thiol-protecting group; and
R is a C₂ to C₄₀ alkyl group possibly containing a heteroatom or an organic group comprising at least two carbon atoms and at least one radical having a strong affinity for the solvent in which it is desired to disperse the nanowires and, optionally, a heteroatom.

When X is hydrogen, the organosulfur derivative is then a thiol compound. However, X may also be a thiol-protecting group, such as, for example an acetate group.

A sulfur atom has a strong affinity for gold and is the point at which the sulfur derivative is grafted onto the gold protuberance.

The R group itself enables the dispersion of the nanowires in solvents to be controlled. Its function is to promote chemical compatibility with the solvent by weak interactions and to increase the contact area between the nanowires and the solvent, i.e. to reduce the mutual interaction of the nanowires, that is to say to increase the distribution of the nanowires throughout the volume. Thus, the R groups comprise at least two carbon atoms in order to increase the contact area between nanowires and solvent, and at least one radical compatible with the solvent in which they are to be dispersed. The R radical may contain a heteroatom, in particular a sulfur atom, in which case the organosulfur derivative may be a disulfide compound. Such a disulfide compound is also a preferred organosulfur derivative of the invention.

Thus, when it is desired to disperse the nanowires in polar solvents, such as alcohols, water, acetone, the R group in formula 1 contains polar functional groups such as a polyethylene glycol hydroxyl or amine radical.

However, when the nanowires are to be dispersed in nonpolar solvents, such as alkanes, aromatic solvents and chlorinated solvents for example, the R group is a C₂ to C₄₀ alkyl or comprises an aromatic radical. A preferred organosulfur derivative of formula 1 is then octadecanethiol.

Finally, when the nanowires are to be dispersed in perfluorinate solvents, the R group comprises at least one perfluorinated radical.

In this case, a preferred organosulfur derivative of formula I used for dispersing nanowires made of a silicon-based material in a perfluorinated solvent is 1H,1H,2H,2H-perfluorodecanethiol.

The invention also provides a method of dispersing nanowires made of a silicon-based material, which include at least one gold particle on their surface, in a solvent, said method including a step of grafting an organosulfur derivative as defined above.

The method of dispersing silicon-based nanowires of the invention enables nanowires made of silicon, made of a silicon-germanium alloy SiGe, or made of an Si/SiGe composite to be dispersed.

The organosulfur derivative will be chosen, as described above, according to the solvent in which the nanowires are to be dispersed.

To gain a better understanding of the invention, one way of implementing it will now be described by purely illustrative and nonlimiting example.

### EXAMPLE

Silicon nanowires 2 μm in length and 50 nm in diameter were grown on a silicon wafer by CVD, using gold as catalyst and SiH₄ as silicon precursor.

Two portions A and B of identical area (1 cm²) were removed from the silicon wafer on which the nanowires were synthesized. These two portions A and B had an equivalent density of nanowires on their surfaces.

Portion A was immersed in 1 ml of perfluoromethycyclohexane for two hours and then subjected to an ultrasonic treatment in the same solvent for 30 seconds. The solution was removed and centrifuged at 14,500 rpm for one minute. A 20 μl droplet of the supernatant was removed for analysis by SEM (scanning electron microscopy). Specimen 1 was obtained.

Portion B was immersed in 1 ml of perfluoromethycyclohexane containing 30 mg of 1H,1H,2H,2H-perfluorodecanethiol for two hours and then subjected to an ultrasonic treatment in the same solution for 30 seconds. The solution was removed and centrifuged at 14,500 rpm for one minute and a 20 μL droplet of supernatant was removed for analysis by SEM. Specimen 2 was obtained.

The SEM analysis showed a clearly larger number of nanowires in specimen 2 compared to specimen 1, in a ratio of at least 1/20.

Thus, a dispersion of silicon-based nanowires comprising at least one gold protuberance on their surface in a liquid was obtained by grafting an organosulfur derivative, namely perfluorodecanethiol, onto at least one gold protuberance on the surface of each nanowire.

Grafting of organosulfur derivatives is in no case incompatible with the use of the resulting grafted nanowires for various applications since it is possible to remove them, for example, by pyrolysis or by oxidation.

The dispersed nanowires thus obtained may be used to produce nanowire-based devices, for example for large-area electronics, sensors, thermoelectricity, optronics, etc.

1. A method of dispersing nanowires made of a silicon-based material, which include at least one gold protuberance on their surface, in a solvent, which method includes a step of grafting, onto at least one gold protuberance of each nanowire, an organosulfur derivative of formula I below:
X—S—R
in which:
X is hydrogen or a thiol-protecting group; and
R is a C₂ to C₄₀ hydrocarbon group possibly containing at least one heteroatom.

2. The method as claimed in claim 1, wherein R comprises a radical chosen from a hydroxyl radical, an amine radical, an aromatic radical, a perfluorinated radical, an ester radical, an amide radical or a sulfonic ester radical.

3. The method as claimed in claim 1 or 2, wherein the solvent is a polar solvent and wherein the group R in formula I is a polyethylene glycol group and/or an organic group comprising at least two carbon atoms and at least one radical chosen from a hydroxyl radical or an amine radical, or an amide radical, or a sulfonic ester radical, and optionally at least one heteroatom.

4. The method as claimed in claim 1 or 2, wherein the solvent is an apolar solvent and wherein R in the formula I is a C₂ to C₄₀ alkyl group or an organic group comprising at least two carbon atoms and at least one aromatic radical and optionally at least one heteroatom.

5. The method as claimed in claim 4, wherein the sulfur derivative of formula I is octadecanethiol.

6. The method as claimed in claim 1 or 2, wherein the solvent is a perfluorinated solvent and wherein R in the formula I is an organic group comprising at least two carbon atoms and a perfluorinated radical and optionally at least one heteroatom different from fluorine.

7. The method as claimed in claim 6, wherein the organosulfur derivative of formula I is 1H,1H,2H,2H-perfluorodecanethiol.

8. The method as claimed in any one of the preceding claims, wherein the silicon-based material is silicon.

9. The method as claimed in any one of the preceding claims, wherein the silicon-based material is an SiGe alloy.

10. The method as claimed in any one of the preceding claims, wherein the silicon-based material is an Si/SiGe composite.

11. A nanowire made of a silicon-based material, the surface of which includes at least one gold protuberance, an organosulfur derivative being grafted onto at least one of these gold protuberances, wherein the organosulfur derivative is chosen from 1H,1H,2H,2H-perfluorodecanethiol and octadecanethiol.

12. The nanowire as claimed in claim 11, wherein the silicon-based material is an SiGe alloy.

13. The nanowire as claimed in claim 11 or 12, wherein the silicon-based material is an Si/SiGe composite.
